(19) United States
(12) Patent Application Publication
(10) Pub. No.: US 2016/0214427 A1
(43) Pub. Date: Jul. 28, 2016

(54) PAINT ROLLER BUCKET

(71) Applicant: George S. Vlahakis, Northville, MI (US)

(72) Inventor: George S. Vlahakis, Northville, MI (US)

(21) Appl. No.: 14/606,261

(22) Filed: Jan. 27, 2015

(51) Int. Cl. B44D 3/12; B65D 25/32; B65D 21/02

(52) U.S. Cl. CPC B44D 3/128; B44D 3/127; B65D 21/0209; B65D 25/32

(57) ABSTRACT

A bucket for use in painting comprises a cylindrical container having a flat base. The bucket also comprises a container having a flat wall extending from the base and the container having an open top. The bucket also comprises a ledge extending from an inside surface of the container wherein the ledge extends to an end of the wall. The bucket also comprises a plurality of vertically aligned ribs extending from the wall a predetermined distance, wherein the plurality of ribs extend in an inward direction from the wall. The paint roller bucket of the present invention may incorporate a roller grate directly into a paint bucket.

### BACKGROUND OF THE INVENTION

1. Field of the Invention

The present invention generally relates to painting tools and, more specifically, relates to a paint roller bucket for use with a paint roller.

2. Description of Related Art

It is well known in the art that painters have used rollers and brushes to paint walls, ceilings, and other surfaces or structures. Typically, the painter may purchase the paint in buckets in various sizes from a typical one gallon size can or a typical five gallon size can, which is generally sold to professional painters and contractors. The painter either may apply the paint to a roller or brush using a roller tray or directly from the bucket in some cases. The painter, after coating the roller or brush in paint, will then apply the paint to a surface in order to cover the wall or other structure with a predetermined color and material. In some instances, professional or commercial painters may roll the roller, before using on a surface, against a grate or similar flat surface, that generally is formed in a tray bottom or may be a separate screen or grate attached to a bucket. These grates are typically made of metal screening and have predetermined metal screen patterns thereon. In the prior art, one type of grate used by commercial painters props up against the wall of a bucket, generally a five gallon bucket, with the upper edge of the grate having a hook that may be hung over the bucket rim to stabilize it. The painter will then dip the roller into the paint in the bucket and then roll it against the grate in the bucket to remove the excess paint, which may allow for a more even distribution of the paint throughout the roller, and hence, onto the wall, ceiling or other surface being painted.

These prior art paint grates, which generally are used with five gallon buckets, have been known in the prior art to fall off the rim of the bucket and slide into the buckets and also have been known to get completely paint covered and gummed up, such that the prior art paint grates are one use paint grates that are either not worth cleaning or take to much time to clean in order to reuse with another type of paint. Furthermore, if the grates get completely filled and gummed with up old used paint, the grates lose its effectiveness of evenly spreading the paint onto the roller, thus creating a painting tool that does not operate in a proper manner. Therefore, there is a need in the art for an improved method of evenly applying paint to a roller for use with a paint can or paint bucket. There also is a need in the art for a paint bucket that incorporates and directly forms a grate type device directly into a bucket. There also is a need in the art for a low cost reusable paint bucket that is capable of having a roller pan or grate integrally formed therein. There also is a need in the art for a roller grate that uses a plurality of vertically aligned ribs extending inwardly from an inside flat surface of a paint bucket. There also is a need in the art for a low cost and easy to manufacture combination paint bucket and roller tray or grate for use in one gallon cans or five gallon buckets of paint.

### SUMMARY OF THE INVENTION

One object of the present invention may be to provide a novel and unique paint roller bucket.

Another object of the present invention may be to provide a paint roller bucket that is for use with both commercial and residential painters.

Still another object of the present invention may be to provide a paint roller bucket that incorporates a roller grate directly into a paint bucket.

Still another object of the present invention may be to provide a paint roller bucket that is resealable and reusable.

Still another object of the present invention may be to provide a paint roller bucket that is stackable with other paint roller buckets in order to provide for easier storage thereof.

Yet another object of the present invention may be to provide a paint roller bucket that includes a ledge and a flat wall arranged within the bucket, wherein the flat wall includes a plurality of vertical ribs arranged thereon.

Still another object of the present invention may be to provide a paint roller bucket that uses a plurality of vertically aligned ribs to create a roller grate or paint spreading surface that may evenly spread paint on the surface of the roller and remove any excess paint therefrom.

Still another object of the present invention may be to provide a paint roller bucket that is capable of storing a full size roller completely therein.

Still another object of the present invention may be to provide a paint roller bucket that eliminates the need for a separate roller grate to be used in conjunction with a traditional paint bucket.

Yet another object of the present invention may be to provide a paint roller bucket that is easy to manufacture thus reducing the cost to incorporate a paint roller grate within a paint bucket.

Yet another object of the present invention may be to provide a paint roller bucket which through incorporation of a roller grate therein makes for easier use of a roller and clean up of painting tools after a painting job.

According to the present invention, the foregoing and other objects and advantages are obtained by a novel design for a paint roller bucket for use in painting. The paint roller bucket generally comprises a cylindrical container having a flat base. The container having a flat wall extending from the base and the container having an open top. The bucket further comprises a ledge extending from an inside surface of the container, wherein the ledge extends to an end of the wall. The bucket also comprises a plurality of vertically aligned ribs extending from the wall a predetermined distance. The plurality of ribs extending in an inward direction into the bucket from the wall.

One advantage of the present invention may be that it provides a novel and unique paint roller bucket.

Another advantage of the present invention may be that it provides for a paint roller bucket that incorporates a paint roller grate or roller surface directly into the bucket.

Still another advantage of the present invention may be that it provides for a paint roller bucket that is stackable with other paint roller buckets and resealable for multiple uses by a painter.

Still another advantage of the present invention may be that it provides for a paint roller bucket that has a ledge and flat wall arranged on an inside surface thereof.

Still another advantage of the present invention may be that it provides for a paint roller bucket that has a plurality of vertically aligned ribs extending from an inside surface of a flat wall arranged within a generally cylindrical bucket.

Yet another advantage of the present invention may be that it provides for a paint roller bucket that is capable of completely storing a full size roller within the bucket.

Still another advantage of the present invention may be that it provides for a paint roller bucket that includes a ledge that is generally parallel to a base or bottom surface of the paint roller bucket.

Still another advantage of the present invention may be that it provides for a paint roller bucket that has a paint roller grate integrated therein and also includes a handle arranged on an outside surface thereon.

Yet another advantage of the present invention may be that it provides for a paint roller bucket that has a ledge and a base that generally has the shape of a circular segment.

Yet another advantage of the present invention may be that it provides for a paint roller bucket that is easier to manufacture and easier to clean thus reducing the costs for the painter.

Yet another advantage of the present invention may be that it provides for a paint roller bucket that is capable of using either a snap on lid or a screw on lid.

Other objects, features and advantages of the present invention may become apparent from the subsequent description and the appended claims, taken in conjunction with the accompanying drawings.

### BRIEF DESCRIPTION OF THE DRAWINGS

FIG. 1 shows a side view of a paint roller bucket according to the present invention.

FIG. 2 shows a top view of a paint roller bucket according to the present invention.

FIG. 3 shows a top view of a rib for use in a paint roller bucket according to the present invention.

FIG. 4 shows a top view of a paint roller bucket according to the present invention.

FIG. 5 shows a side view of a paint roller bucket according to the present invention.

FIG. 6 shows a side view of a paint roller bucket with a lid according to an embodiment of the present invention.

FIG. 7 shows a top view of a paint roller bucket according to the present invention.

FIG. 8 shows a perspective view of a paint roller bucket according to the present invention.

FIG. 9 shows a screw on lid for use with a paint roller bucket according to the present invention.

FIG. 10 shows an alternate embodiment of a paint roller bucket according to the present invention.

### DESCRIPTION OF THE EMBODIMENT(S)

Referring to the drawings, a paint roller bucket 20 is shown according to the present invention. The paint roller bucket 20 generally is made of a plastic material. It should be noted that the paint roller bucket 20 may be made of any other known material including, but not limited to, any other known plastic, composite, natural material, metal, etc. The paint roller bucket 20 may be capable of being stackable with other paint roller buckets and also be capable of being resealed, thus allowing for the storage of unused paint in an air tight structure. It is contemplated to use any known lid 22, such as a snap on lid or a screw on lid, etc., to seal the paint roller bucket 20 according to the present invention. In one embodiment contemplated a generally cylindrical shape may be used for the paint roller bucket 20, however any other shape may be used for the paint roller bucket 20, such as a square bucket, a rectangular bucket or any other known shaped bucket may also be used according to the present invention. Any shaped bucket may be used as long as the paint roller bucket 20 has the necessary width to receive a standard paint roller and brush therein for use by the painter. The paint roller bucket 20 may also include a bucket handle 24 arranged and secured to an outside surface of the paint roller bucket 20. Generally, the paint roller bucket 20 may be used by any type of painter, such as a do-it-yourselfer or a professional painter. The paint roller bucket 20 may be used to paint homes, buildings, or any other known structure or surfaces. In the prior art, a paint bucket generally was used with a paint roller grate, wherein the paint roller grate was removably attachable to an outer rim of a paint bucket and allowed for the paint roller to be rolled along a generally metal grate surface. This prior art setup would allow for the paint roller to evenly spread the paint on the roller and to remove any excess paint from the roller before rolling the paint onto a wall or other surface. These prior art paint roller grates generally would become gummed up with previously dried paint and may also dislodge from the rim of the bucket and fall into the paint, thus reducing the efficiency of the painters and create a messy clean up situation. Furthermore, if the paint grates were not cleaned after each use and old paint hardened and became permanently stuck to the grate, clean up may be impossible and the old paint roller grates would almost become one time use grates, thus increasing the cost to the painters. The paint roller bucket 20 of the present invention may directly incorporate into a bucket a paint roller grate on a flat wall 26 that is arranged from a base of a generally cylindrical paint roller bucket 20.

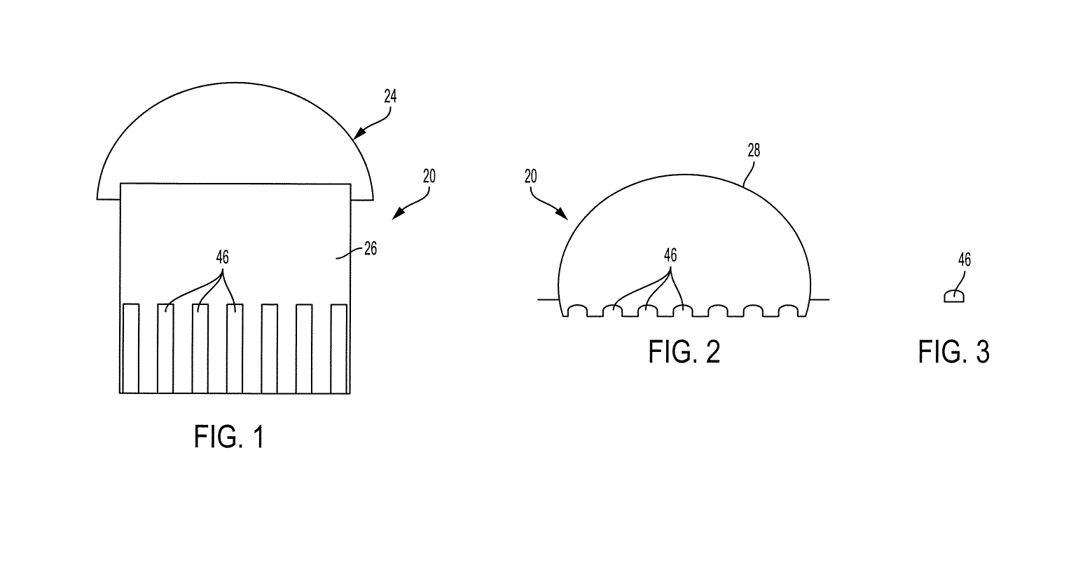

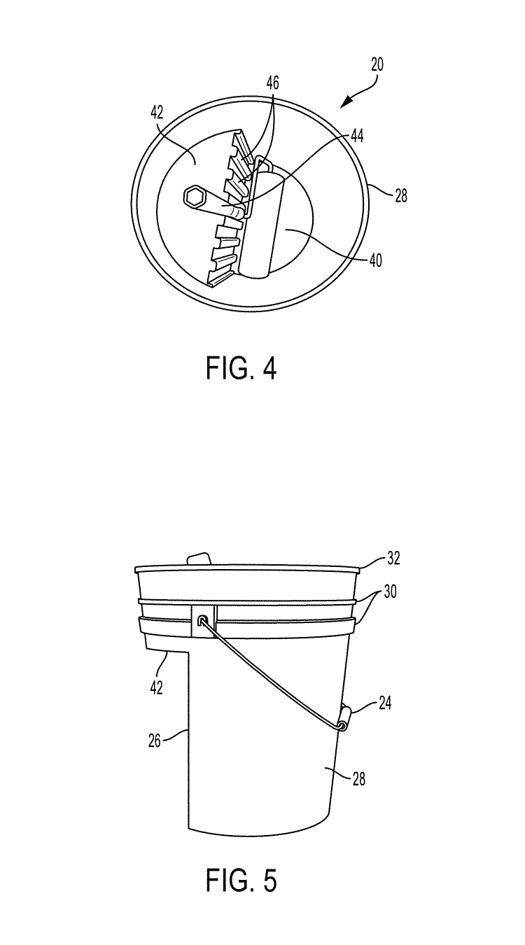

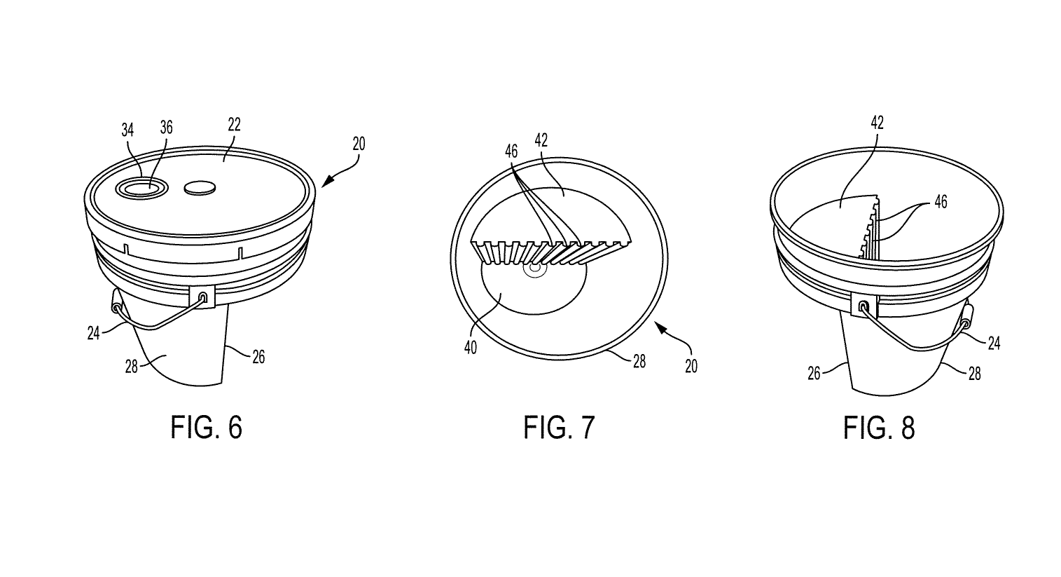

In one contemplated embodiment as shown in FIGS. 1 through 9, the paint roller bucket 20 of the present invention may be used in any size or shape. The paint roller bucket 20 may be of the five gallon commercial size, a one gallon do-it-yourselfer personal size or any other size. The paint roller bucket 20 may also have any known shape other than the cylindrical circular shape shown in the drawings. Generally, the paint roller bucket 20 of the present invention is a generally cylindrical container 28. The cylindrical container 28 generally may have an open top that has a generally circular shape. The generally circular shape on the open top of the cylindrical container 28 may extend in an downward direction a predetermined distance. The paint roller bucket cylindrical container 28 may include a plurality of flanges 30 extending from an outer surface thereof at or near a top portion of the cylindrical container 28. One of these flanges 30 may be used to secure a handle 24 to the container 28 and may also allow for the paint roller bucket 20 to be stackable without completely sliding within one another. The very top edge of the cylindrical container 28 may also have arranged thereon a lip 32 around the complete outer circumference thereof. The lip 32 may be used to interact with a reciprocal circumferential locking surface arranged on an inner surface of a snap on lid 22. It should further be noted that the snap on lid 22 may also include an orifice 34 therein. The orifice 34 may have any type of plug 36 arranged therein to allow for an easy pour access for the paint inside the container 28 without removing the lid 22. The lid 22 may also include a gasket 38 around an inner circumferential groove thereof to ensure a complete air tight seal of the paint roller bucket 20, thus increasing the longevity and shelf life of any remaining paint stored therein. Generally, the open top has a circular diameter that is approximately eleven inches. However, any other diameter may be used for the open top or bottom of the paint roller bucket 20 of the present invention. The cylindrical container 28 may also include a slightly smaller diameter at a bottom or base 40 of the paint roller bucket 20. In one contemplated embodiment this lower diameter may be approximately ten inches. It should be noted that the diameter at the top and bottom of the container 28 may also be the same. The container 28 may also have any known height from its base 40 to its top. In one contemplated embodiment the height of the paint roller bucket 20 is approximately sixteen inches, however any other height from three inches up to twenty four inches may also be used for the paint roller bucket 20 according to the present invention. It should be noted that the diameters of the top portion of the paint roller bucket 20 and the bottom or base 40 of the paint roller bucket 20 may be anywhere from two inches up to twenty four inches depending on the size of the paint roller bucket 20 and the environment in which the paint roller bucket 20 may be used.

The paint roller bucket 20 of the present invention generally may include a flat base 40 arranged at a bottom of the generally cylindrical container 28. The flat base 40 in one contemplated embodiment may have a generally circular segment like shape. It should be noted that any other shape may also be used for the base 40. This circular segment like shape for the base 40 of the paint roller bucket 20 according to the present invention generally may be greater than a semi-circle but at least a width of a semi-circular. In one contemplated embodiment the base 40 of the paint roller bucket 20 is approximately six inches when measured from an inner cylindrical wall to a flat wall 26 extending therefrom. The paint roller bucket 20 of the present invention may have a flat wall 26 extending from the base 40 of the cylindrical container 28. The wall 26 may have any known shape, in the embodiment shown it has a generally rectangular shape. The flat wall 26 generally may extend a predetermined distance from the flat base 40 towards the top of the container 28. The flat wall 26 generally may be perpendicular to the base 40, however a predetermined angle may also be used with respect to the base 40 for the flat wall 26 of the cylindrical container 28. The flat wall 26 may extend a predetermined distance from the base 40 towards the top of the paint roller bucket 20. In one contemplated embodiment the flat wall 26 may extend approximately ten inches from the base 40 towards the top of the paint roller bucket 20. Extending at generally a right angle from a top surface of the flat wall 26 may be a ledge 42 of the paint roller bucket 20. The ledge 42 generally may be perpendicular to the flat wall 26, however it may also have an angle with respect to the flat wall 26. Hence, the ledge 42 may be parallel to the base 40 of the paint roller bucket 20 or may have an angle in relation to the base 40 of the paint roller bucket 20. The ledge 42 generally may have a width from an inside surface of the container 28 to the flat wall 26 of approximately four inches when measured along a diameter of the paint roller bucket 20. The ledge 42 generally may have a circular segment shape when viewed from the top of the paint roller bucket 20. It should be noted that any other shape may also be used for the ledge 42. The circular segment shape along with the circular segment shape defined by the base 40 of the container 28 generally may form a complete circle when viewed from above. The ledge 42 of the paint roller bucket 20 of the present invention in one contemplated embodiment is approximately four inches in length when measured along a diameter of the paint roller bucket 20. However, it should be known that any other length for the ledge 42 may be used, anywhere from one inch up to the entire diameter of the paint roller bucket 20. It should further be noted that the length of the base 40 of the paint roller bucket 20 according to one embodiment of the present invention is approximately six inches when taken along a diameter of the container 28 of the paint roller bucket 20. However, it should be noted that any other length may be used for the base 40 of the paint roller bucket 20, from approximately a semi-circle up to a full diameter of the paint roller bucket 20. The base 40 of the paint roller bucket 20 may have a length sufficient enough to allow for the paint roller bucket 20 to stand on its own when empty and when full with paint and not tip over during use or storage thereof. Therefore, generally the length of the base 40 has to be greater than or equal to at least the radius of the base 40 of the paint roller bucket 20. It should also be noted that it is contemplated to secure a leg from a bottom portion of the ledge 42 in a downward direction such that the leg may end on the same plane as the base 40 of the paint roller bucket 20. This leg may be used to provide additional support so the paint roller bucket 20 does not tip over during use. It should further be noted that the wall 26 of the paint roller bucket 20 may have any predetermined width. In one contemplated embodiment the width may be approximately ten and one half inches. However, any other dimension may be used for the width of the wall 26 depending on the painting equipment, such as the paint roller 44 or brush to be used with the paint roller bucket 20. Generally, a standard paint roller 44 has a width of approximately ten inches, hence the wall 26 has to be at least ten inches wide or may be wider than that or may be smaller than that if a smaller roller is used.

The paint roller bucket 20 also may include a plurality of ribs 46 aligned on an inside surface of the flat wall 26. The plurality of ribs 46 are vertically aligned and extend from the base 40 in an upward direction to the top edge of the wall 26 in one contemplated embodiment. The ribs 48 may be evenly spaced along the flat wall 26. Any number of ribs 46 may be used on the flat wall 26 of the present invention. In one contemplated embodiment approximately seven ribs 46 may be used on the flat wall 26 of the present invention. It should be noted that the ribs 46 extend a predetermined distance towards the inside portion of the paint roller bucket 20. The extension of the ribs 46 in an inward direction with relation to the container 28 may allow for the paint roller bucket 20 to be stackable with one another when not in use. It is contemplated to have the ribs 46 directly molded into the flat wall 26 during molding of the entire paint roller bucket 20. It is also contemplated to secure the ribs 46 directly onto the wall 26 after initial manufacture of the paint roller bucket 20. The ribs 46 may be secured via any known mechanical or chemical fastening technique, such as gluing, epoxy or the like. The ribs 46 being evenly space may allow for a predetermined gap to be arranged between the ribs 46. This predetermined gap may be anywhere from one quarter inch up to two inches depending on the design requirements of the paint roller bucket 20. The gap may have any known shape, such as but not limited to the right angled surfaces or partial rectangular shape as shown in some of the figures. As stated above, the plurality of ribs 46 generally extend the entire length of the flat wall 26, hence the ribs 46 may be approximately ten inches in length. However, it is also contemplated to have the ribs 46 not extend the entire distance of the flat wall 26 and only extend a predetermined distance from the base 40. It is also contemplated to have the ribs 46 include on the top end thereof an angled surface that may taper down to the edge of the wall 26 where the ledge 42 meets therewith. In one contemplated embodiment the paint roller bucket 20 may have a rib 46 that generally has a width of approximately one inch and a depth of approximately one half inch, wherein the depth is the portion that extends inwardly into the cavity of the cylindrical container 28 of the paint roller bucket 10. However, it should be noted that any other dimensions for the ribs 46 may also be used, wherein the ribs 46 may be anywhere from one quarter inch wide up to three inches wide and their depth may be anywhere from one sixteenth of an inch up to two inches depending on the design requirements and the environment in which the paint roller bucket 20 may be used. In one contemplated embodiment, the rib 46 may generally have a D-shape when viewed from a top. The use of a D-shape rib 46 may ensure an even spread of the paint on the roller 44 and removal of any excess paint from the roller 44 during use of the paint roller bucket 20. It should be noted that in the contemplated embodiment, the plurality of ribs 46 are vertically aligned such that each of the ribs 46 are parallel to one another and perpendicular to the base 40. However, it should be noted that any other known shape may also be used for the ribs 46, such as horizontal, triangular, circular or any other known configuration for the ribs 46 arranged on the inner surface of the flat wall 26 of the paint roller bucket 20. It should also be noted that any other shape may be used for the rib 46 other than the D-shape as shown in the drawings. A triangular shape, a circular shape, square shape or any other random or known shape may be used for the cross section of the ribs 46 or when viewed from above. It should be noted that the paint roller bucket 20 and the ribs 46, ledge 42 and wall 26 are all made of the same material as described above.

In use, the paint roller bucket 20 may be filled with paint to a predetermined height. The painter may then apply paint to a roller 44, such as by dipping it into a pool of paint in the bottom or receptacle portion of the paint roller bucket 20. The painter may then roll the roller 44 against the plurality of vertically aligned ribs 46. This rolling action may squeeze any excess paint from the roller and evenly spread the paint on the roller 44 for use on painting the surface the painter may be painting. The squeezing of the roller 44 against the vertically aligned ribs 46 may allow for any excess paint to drip back down into the bottom or receptacle portion of the paint roller bucket 20. It is also contemplated that the paint roller bucket 20 may be used in combination with any type of paint or other suitable material for application with a roller 44. It is further contemplated that the paint roller bucket 20 may be sold pre-filled with paint or other material or sold empty depending on the environment in which the paint roller bucket 20 is used. If the paint roller bucket 20 is pre-filled with paint it is then sealed with a lid 22 and sold as an integral product. This may allow for the paint roller bucket 20 to function both as a bucket in which paint is conventionally sold and one in which paint is pre-filled into the bucket sold therein and then is capable of being resealed via a lid 22 as described above. The snap on lid 22 may allow for an air tight seal to be used on the paint, thus the paint may be reused at a later time by the painter. As described above, it is also contemplated that the paint roller bucket 20 may have a height that may allow for storage of paint rollers 44 therein after the paint roller bucket 20 is used by the painter. The use of a generally plastic material to create the paint roller bucket 20 may allow for easy cleaning, storage and recyclability of the paint roller bucket 20 upon the purchase by a painter. The paint generally is easily cleaned from the paint roller bucket 20 by rinsing it out with water, paint thinner or other suitable material that is capable of removing paint from plastic products. This includes the integrated vertically aligned ribs 46, which act as a roller grate according to the present invention and is directly incorporated into the paint roller bucket 20 of the present invention.

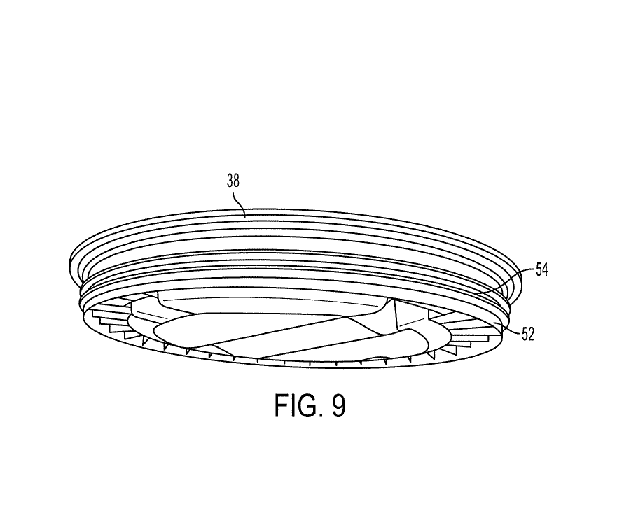

FIG. 9 shows an alternate embodiment for a paint roller bucket lid 52. This alternate embodiment generally includes a screw on version of the paint roller bucket lid 52. The paint roller bucket lid 52 may generally incorporate a predetermined number of threads 54 arranged an outer circumference of the lid 52. Arranged at a top portion of the lid may be a lip 52, which may have an O-ring seal 38 placed thereon. This may allow for the screw on lid 52 to be screwed onto the top portion of the cylindrical container 28 of the paint roller bucket 20. The paint roller bucket 20 in this embodiment may have a reciprocal thread arranged around an inside upper circumference of a top end of the paint roller bucket 20. Thus, the screw on lid 52 may be screwed onto the threads of the paint roller bucket container 28 and create a seal between the O-ring and the top lip of the paint roller bucket container 28. This may allow for an air tight seal between the paint and the outside air in which the paint roller bucket 20 is used.

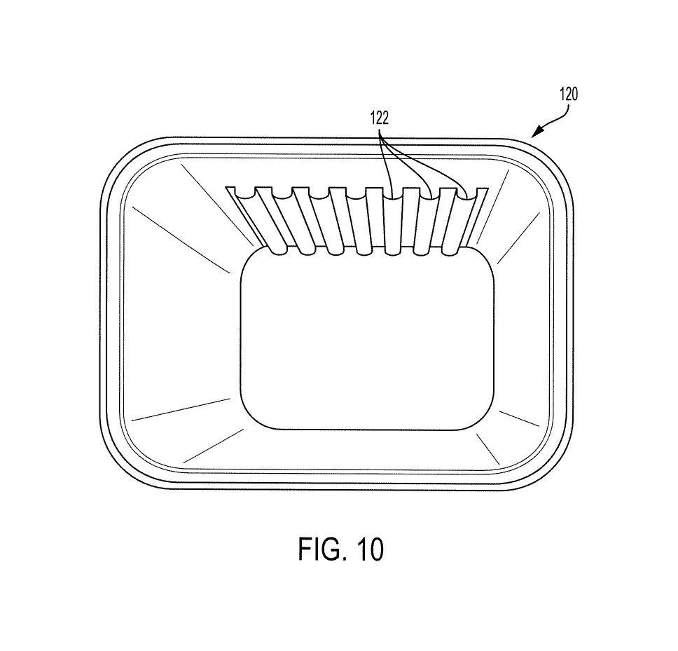

As shown in FIG. 10 an alternate embodiment for the paint roller bucket 120 is shown. In this alternate embodiment the paint roller bucket 120 generally has a rectangular shape with any known size. In the embodiment contemplated it may have a width of approximately eleven and one half inches on the longer side thereof and approximately nine inches on the shorter side thereof. This may allow a standard roller 44 that is approximately ten inches wide to be used therein. In this embodiment the ribs 122 may be evenly spaced on the inside surface of one of the longer sides of the rectangular paint roller bucket 120. The ribs 122 may be molded directly therein or fastened after molding of the rectangular bucket 120 as described above. The height of the bucket 120 may be approximately sixteen inches but may be in the range as described above for the cylindrical container 28. However, the cylindrical bucket or the alternate embodiment bucket may be any known height from five inches high up to twenty four inches high depending on the design requirement and the environment in which the paint roller bucket 20 may be used. Hence, the rectangular paint roller bucket 120 may be used in the same manner as a circular paint roller bucket 20 and that paint may be applied to the roller 44 and then the roller 44 may be rolled along the ribs to remove any excess paint and evenly spread the paint on the roller 44. It should be noted that any other shape may also be used for the paint roller bucket 20 of the present invention as long as it has one flat wall side with a width of approximately ten inches in order to have a standard roller 44 used thereon.

The present invention has been described in an illustrative manner. It is to be understood that the terminology which has been used is intended to be in a nature of words of description rather than that of limitation.

Many modifications and variations of the present invention are possible in light of the above teachings. Therefore, within the scope of the appended claims, the present invention may be practiced otherwise than as specifically described.

1. A bucket, said bucket comprising:
a generally cylindrical container having a flat base, said container having a flat wall extending from said base, said container having an open top;
a ledge extending from an inside surface of said container, said ledge extends to an end of said wall; and
a plurality of vertically aligned ribs extending from a said wall a predetermined distance, said plurality of ribs extending in an inward direction from said wall, said plurality of ribs are parallel to one another and perpendicular to said base, said plurality of ribs evenly spread a paint and remove excess said paint from a roller or brush.

2. The bucket of claim 1 further comprising a lid.

3. The bucket of claim 2 wherein said lid is a screw on device.

4. The bucket of claim 2 wherein said lid is an interference fit or snap on device.

5. The bucket of claim 1 further comprising a handle secured to an outer surface of said container.

6. The bucket of claim 1 wherein said wall and said ledge generally form an L-shape when viewed from a side.

7. The bucket of claim 1 wherein said wall extends approximately ten includes from said base.

8. The bucket of claim 1 wherein said wall is generally perpendicular to said base or has a predetermined angle with respect to said base.

9. The bucket of claim 1 wherein said ribs extend an entire length of said wall.

10. The bucket of claim 1 wherein said ribs have a predetermined gap arranged therebetween, said ribs allow a plurality of the buckets to be stackable with one another.

11. The bucket of claim 1 wherein said ribs have a width of approximately one inch.

12. The bucket of claim 1 wherein said ribs have a depth of approximately one half inch.

13. The bucket of claim 1 wherein said ribs have a generally D-shape or U-shape when viewed from a top.

14. The bucket of claim 1 wherein said ribs are evenly spaced from one another on said wall.

15. The bucket of claim 1 wherein said ledge has a generally circular segment shape, said ledge is arranged a predetermined distance below a top edge of said container.

16. The bucket of claim 15 wherein said ledge is parallel to said base or has a predetermined angle with respect to said base, said ledge extending approximately four inches from a surface of said container along a diameter of said container.

17. The bucket of claim 1 wherein said base has a generally circular segment shape.

18. The bucket of claim 1 wherein said top has a circle shape.

19. The bucket of claim 17 wherein said base measures approximately seven inches from a surface of said container along a diameter of said container.

20. The bucket of claim 17 wherein one of the bucket is stackable in another of the bucket, said container having a height sufficient to hold a roller handle completely inside thereof.
